(19) United States
(12) Patent Application Publication
(10) Pub. No.: US 2019/0145540 A1
(43) Pub. Date: May 16, 2019

(54) SOLENOID VALVE

(71) Applicant: KYB Corporation, Tokyo (JP)

(72) Inventor: Toru TAKEUCHI, Kanagawa (JP)

(73) Assignee: KYB Corporation, Tokyo (JP)

(21) Appl. No.: 15/759,518

(22) PCT Filed: Aug. 26, 2016
(86) PCT No.: PCT/JP2016/075057

§ 371 Date: Mar. 12, 2018

(30) Foreign Application Priority Data
Sep. 16, 2015 (JP) 2015-182855

(51) Int. Cl. F16K 31/06

(52) U.S. Cl. CPC F16K 31/06

(57) ABSTRACT

A solenoid valve includes a main valve configured to change a communication opening degree between a first port and a second port, a control pressure chamber configured to bias the main valve in a valve closing direction, an auxiliary valve configured to open and close a first communication passage and a second communication passage formed in the main valve, a solenoid portion configured to displace the auxiliary valve, a back pressure chamber and a sub-return spring configured to bias the auxiliary valve in a valve closing direction, and a pressure compensation unit configured to change a biasing force of the sub-return spring acting on the auxiliary valve according to a pressure in the back pressure chamber.

### TECHNICAL FIELD

The present invention relates to a solenoid valve.

### BACKGROUND ART

Generally, in hydraulically operated construction machinery and industrial machinery, a solenoid valve is used which controls a flow rate of hydraulic oil according to an electromagnetic force.

A solenoid valve including a main valve for changing a communication opening degree between a first port and a second port, a control pressure chamber for biasing the main valve in a valve closing direction by having hydraulic oil introduced thereto from the first port, and a solenoid portion for controlling a pressure in the control pressure chamber by allowing communication between the control pressure chamber and the second port is described in JP2007-239996A. This solenoid valve further includes a pressure compensation unit for keeping a drive current of the solenoid portion constant regardless of a pressure difference between the first port and the second port.

### SUMMARY OF INVENTION

In the solenoid valve disclosed in JP2007-239996A, the main valve is provided with a piston and a disc spring constituting the pressure compensation unit. This complicates the structure of the main valve and the manufacturing cost of the solenoid valve may increase.

The present invention aims to simplify the structure of a solenoid valve including a pressure compensation unit.

According to one aspect of the present invention, a solenoid valve for controlling a flow rate of working fluid flowing from a first port to a second port includes a main valve configured to change a communication opening degree between the first port and the second port; a control pressure chamber configured to bias the main valve in a valve closing direction by having the working fluid introduced thereto from the first port; a communication passage formed in the main valve, the communication passage being configured to allow communication between the control pressure chamber and the second port; an auxiliary valve configured to open and close the communication passage; a solenoid portion configured to displace the auxiliary valve according to a supplied current; a back pressure chamber communicating with the control pressure chamber, the back pressure chamber being configured to bias the auxiliary valve in a valve closing direction; a first biasing member housed in the back pressure chamber, the first biasing member being configured to bias the auxiliary valve in the valve closing direction; and a pressure compensation unit configured to change a biasing force of the first biasing member acting on the auxiliary valve according to a pressure in the back pressure chamber.

### BRIEF DESCRIPTION OF DRAWINGS

FIG. 1 is a sectional view of a solenoid valve according to a first embodiment of the present invention;

FIG. 2 is a sectional view of a solenoid valve according to a second embodiment of the present invention; and

FIG. 3 is a sectional view of a solenoid valve according to a third embodiment of the present invention.

### DESCRIPTION OF EMBODIMENTS

Hereinafter, embodiments of the present invention are described with reference to the accompanying drawings.

### First Embodiment

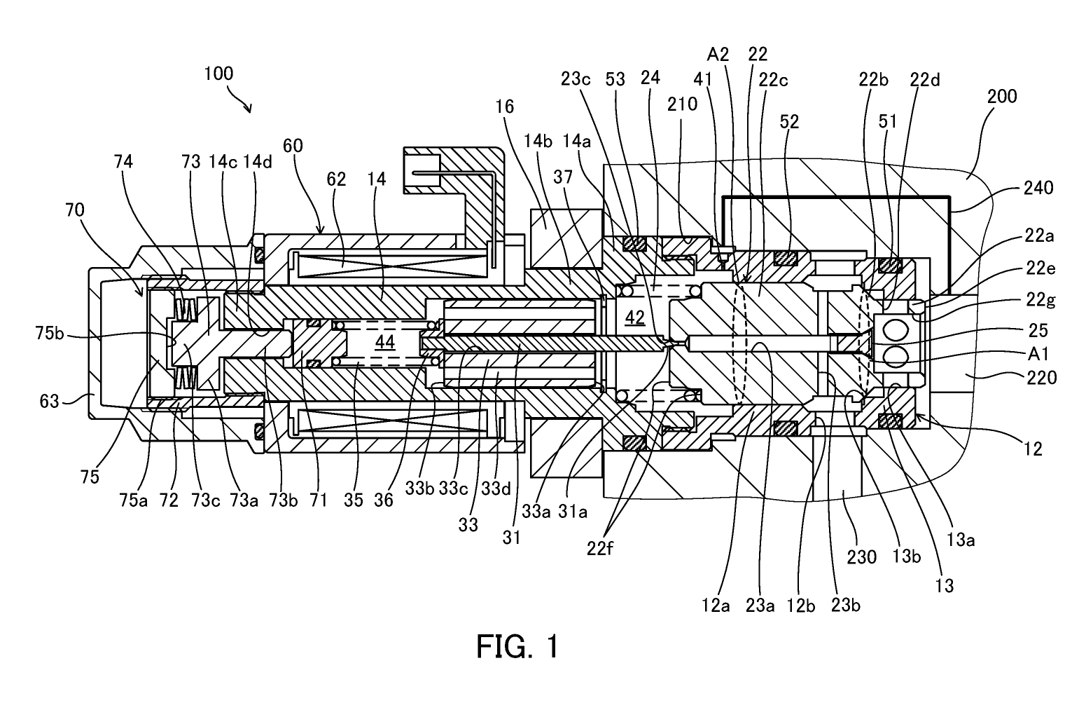

A solenoid valve 100 according to a first embodiment of the present invention is described with reference to FIG. 1. The solenoid valve 100 shown in FIG. 1 is provided in a construction machine, an industrial machine or the like and controls a flow rate of working fluid supplied from an unillustrated fluid pressure source to an actuator (load) and a flow rate of the working fluid discharged from the actuator to a tank or the like.

The solenoid valve 100 is inserted and fixed in a non-penetrating insertion hole 210 provided in a valve block 200. The valve block 200 includes a first port 220 having one end open in the bottom surface of the insertion hole 210 and the other end open in the outer surface of the valve block 200 and connected to the fluid pressure source through unillustrated piping, and a second port 230 having one end open in the side surface of the insertion hole 210 and the other end open in the outer surface of the valve block 200 and connected to the actuator through unillustrated piping.

In the solenoid valve 100, hydraulic oil is used as the working fluid. The hydraulic oil flows from the first port 220 to the second port 230. The working fluid is not limited to the hydraulic oil and may be another non-compressible fluid or compressible fluid.

The solenoid valve 100 includes a main valve 22 that changes a communication opening degree between the first port 220 and the second port 230, a sleeve 12 in the form of a hollow cylindrical tube fixed in the insertion hole 210 and having the main valve 22 slidably inserted thereinto, a control pressure chamber 42 that biases the main valve 22 in a valve closing direction by having the hydraulic oil introduced thereto from the first port 220, an auxiliary valve 31 that changes a communication opening degree between the control pressure chamber 42 and the second port 230, a solenoid portion 60 that displaces the auxiliary valve 31 according to a supplied current, and a pressure compensation unit 70 that changes a biasing force acting on the auxiliary valve 31 according to a pressure in the control pressure chamber 42.

The sleeve 12 includes a sliding support portion 12a that slidably supports the outer peripheral surface of the main valve 22, and a seat portion 13 on which the main valve 22 is seated.

Two seat portions, i.e. a first seat portion 13a in the form of a circular hole and a truncated conical second seat portion 13b, are successively formed on the inner periphery of the seat portion 13 from the side of the first port 220. A center axis of the first seat portion 13a and that of the second seat portion 13b coincide with a center axis of the sleeve 12.

A plurality of communication holes 12b allowing communication between a space in the sleeve 12 and the second port 230 are formed between the second seat portion 13b and the sliding support portion 12a while being circumferentially spaced apart.

O-rings 51, 52 are respectively arranged on the outer periphery of the seat portion 13 and that of the sliding support portion 12a to sandwich the communication holes 12b. Connecting parts of the communication holes 12b and the second port 230 are sealed by these two O-rings 51, 52 compressed between the sleeve 12 and the insertion hole 210. Particularly, the communication of the first port 220 and the second port 230 through a clearance between the sleeve 12 and the insertion hole 210 is prevented by the O-ring 51 provided on the outer periphery of the seat portion 13.

The main valve 22 is a cylindrical member and so arranged in the sleeve 12 that one end surface 22e is located on the side of the seat portion 13 and a sliding portion 22c is slidably supported on the sliding support portion 12a.

A cylindrical spool valve 22a to be slidably inserted into the first seat portion 13a is formed on the side of the one end surface 22e of the main valve 22, and a truncated conical poppet valve 22b to be seated on the second seat portion 13b is formed between the spool valve 22a and the sliding portion 22c.

On the one end surface 22e of the main valve 22, a recess 22g communicating with the first port 220 is formed on the same axis as the spool valve 22a. A plurality of through holes 22d each having one end open in a sliding surface against the first seat portion 13a and the other end open in the inner peripheral surface of the recess 22g are formed in the spool valve 22a while being circumferentially spaced apart.

Each through hole 22d closed by the first seat portion 13a is gradually opened as the spool valve 22a moves in a separating direction of the poppet valve 22b and the second seat portion 13b. That is, the area of each through hole 22d exposed from the first seat portion 13a changes according to a movement amount of the spool valve 22a. As just described, the flow rate of the hydraulic oil flowing from the first port 220 to the second port 230 can be controlled by changing an opening area of each through hole 22d.

Each through hole 22d is arranged not to be completely closed by the first seat portion 13a even if the poppet valve 22b comes into contact with the second seat portion 13b. That is, the opening area of each through hole 22d is smallest at a valve closing position where the poppet valve 22b comes into contact with the second seat portion 13b and gradually increases as the poppet valve 22b is displaced in a valve opening direction.

It should be noted that each through hole 22d may be arranged to be closed by the first seat portion 13a until the poppet valve 22b is separated to a certain degree from the second seat portion 13b. In this case, the flow rate of the hydraulic oil can be set substantially at zero until the main valve 22 is displaced to a certain degree.

Another end surface 22f of the main valve 22 is facing the control pressure chamber 42 defined by the main valve 22, the sleeve 12 and the solenoid portion 60.

The valve block 200 further includes a pressure introducing passage 240 connecting the first port 220 and the control pressure chamber 42. The pressure introducing passage 240 communicates with the control pressure chamber 42 through an introducing hole 41 formed in the sleeve 12 and functioning as an orifice. A check valve for preventing the back-flow of the hydraulic oil introduced to the control pressure chamber 42 to the first port 220 may be provided in the pressure introducing passage 240.

Thus, if a pressure of the first port 220 is higher than that in the control pressure chamber 42, the hydraulic oil in the first port 220 is introduced to the control pressure chamber 42 through the pressure introducing passage 240, a check valve 241 and the introducing hole 41. On the other hand, if the pressure in the control pressure chamber 42 is higher than that of the first port 220, the flow of the hydraulic oil from the control pressure chamber 42 to the first port 220 is blocked by the check valve 241.

A main return spring 24 is provided in a compressed state between the main valve 22 and the solenoid portion 60 in the control pressure chamber 42.

A biasing force of the main return spring 24 acts in a direction to close the main valve 22. Further, the pressure of the first port 220 acts on a valve opening pressure receiving surface A1 equivalent to a cross-section in the second seat portion 13b of the main valve 22 and acts in a direction to open the main valve 22. Further, the pressure in the control pressure chamber 42 acts on a valve closing pressure receiving surface A2 equivalent to a cross-section in the sliding portion 22c and acts in a direction to close the main valve 22. Thus, the main valve 22 is displaced in the valve opening direction if a thrust force by the pressure of the first port 220 acting on the valve opening pressure receiving surface A1 exceeds a resultant force of a thrust force by the pressure in the control pressure chamber 42 acting on the valve closing pressure receiving surface A2 and the biasing force of the main return spring 24, and displaced in the valve closing direction if the above-mentioned thrust force falls below the above-mentioned resultant force.

The main valve 22 further includes a first communication passage 23a and a second communication passage 23b serving as a communication passage for allowing communication between the control pressure chamber 42 and the second port 230.

The first communication passage 23a is a penetrating hole formed in the main valve 22 so that a center axis thereof coincides with that of the main valve 22, one end thereof is open in the other end surface 22f and the other end thereof is open in the recess 22g. Thus, the first communication passage 23a can be simultaneously processed in processing the recess 22g of the main valve 22 or the like. Since a plug 25 is embedded at an opening end of the first communication passage 23a on the side of the recess 22g, the first communication passage 23a and the first port 220 do not communicate.

The second communication passage 23b is formed in a radial direction of the main valve 22 and has one end communicating with the first communication passage 23a and the other end open in the outer peripheral surface of the main valve 22. The other end of the second communication passage 23b is arranged to constantly communicate with the communication holes 12b in a range where the main valve 22 is displaced in the axial direction.

A truncated conical sub-seat portion 23c is formed at an opening end of the first communication passage 23a on the side of the control pressure chamber 42. The auxiliary valve 31 to be driven by the solenoid portion 60 is seated on the sub-seat portion 23c.

The auxiliary valve 31 is a cylindrical member and a sub-poppet valve 31a shaped to come into contact with the sub-seat portion 23c is formed on one end. Further, the other end is coupled to a circular annular spring seat 36.

When the sub-poppet valve 31a and the sub-seat portion 23c come into contact, the communication between the control pressure chamber 42 and the first communication passage 23a is blocked. On the other hand, if the sub-poppet valve 31a is separated from the sub-seat portion 23c and a clearance is formed between the sub-poppet valve 31a and the sub-seat portion 23c, the control pressure chamber 42 and the first communication passage 23a communicate. Thus, the hydraulic oil in the control pressure chamber 42 is discharged to the second port 230 through the first and second communication passages 23a, 23b. Although the hydraulic oil is introduced to the control pressure chamber 42 through the pressure introducing passage 240, the inflow of the hydraulic oil into the control pressure chamber 42 is limited by the introducing hole 41. As a result, the pressure in the control pressure chamber 42 decreases.

The size of the clearance between the sub-poppet valve 31a and the sub-seat portion 23c is adjusted by changing the position of the auxiliary valve 31 in the axial direction. Since the axial position of the auxiliary valve 31 is controlled by the solenoid portion 60, the size of this clearance is controlled by the solenoid portion 60.

The solenoid portion 60 includes a coil 62 that generates a magnetic attraction force by having a current supplied thereto and a solenoid tube 14 in the form of a bottomed tube having the coil 62 provided on an outer periphery.

The solenoid tube 14 includes an inserting portion 14a to be inserted into the insertion hole 210 of the valve block 200 and a small diameter portion 14b having a smaller outer diameter than the inserting portion 14a and arranged outside the insertion hole 210. The solenoid tube 14 is threadably engaged with the sleeve 12 in the inserting portion 14a. The coupling of the solenoid tube 14 and the sleeve 12 is not limited to screw coupling and may be fitting coupling.

An O-ring 53 serving as a sealing member is arranged on the outer periphery of the inserting portion 14a. Communication between the inside and outside of the insertion hole 210 is blocked by the O-ring 53 compressed between the solenoid tube 14 and the insertion hole 210. Thus, the leakage of the hydraulic oil in the insertion hole 210 to outside is prevented and the entrance of water, dust and the like into the insertion hole 210 from outside is prevented.

A fastening member 16 is loosely fitted on the outer periphery of the small diameter portion 14b. The fastening member 16 is fastened to the valve block 200 via an unillustrated bolt with an inner peripheral part locked to the inserting portion 14a. By fastening the fastening member 16 to the valve block 200, the solenoid valve 100 is fixed to the valve block 200.

A plunger 33 to be attracted to the coil 62 and a piston 71 constituting the pressure compensation unit 70 to be described later are slidably housed in the solenoid tube 14. The plunger 33 is arranged such that one end 33a thereof faces the control pressure chamber 42. A back pressure chamber 44 is defined by another end 33b of the plunger 33 and the piston 71 in the solenoid tube 14.

The plunger 33 includes a through hole 33c penetrating through an axial center and a plurality of communication holes 33d formed around the through hole 33c and penetrating in the axial direction. Thus, the back pressure chamber 44 and the control pressure chamber 42 are connected by the plurality of communication holes 33d. Further, the auxiliary valve 31 is loosely inserted into the through hole 33c from the side of the other end 33b and locked to the plunger 33 via the spring seat 36.

Further, a sub-return spring 35 serving as a first biasing member to be interposed in a compressed state between the spring seat 36 and the piston 71 is arranged in the back pressure chamber 44. Thus, the auxiliary valve 31 and the plunger 33 are biased in a direction to seat the sub-poppet valve 31a on the sub-seat portion 23c by a biasing force of the sub-return spring 35 and a pressure in the back pressure chamber 44.

Further, a C-shaped stopper ring 37 is locked to the inner peripheral surface of the solenoid tube 14. The stopper ring 37 is provided to prevent the plunger 33 from coming out by being pushed back by the sub-return spring 35 after the plunger 33 is assembled into the solenoid tube 14.

Next, the configuration of the pressure compensation unit 70 is described.

The pressure compensation unit 70 includes the piston 71 provided in the solenoid tube 14, a pressing member 73 that presses the piston 71 by coming into contact with the piston 71, disc springs 74 serving as a second biasing member for biasing the pressing member 73 toward the piston 71, and an adjusting member 75 arranged with the disc springs 74 interposed between the pressing member 73 and the adjusting member 75.

The pressing member 73 includes a disc-shaped body portion 73a, a rod portion 73b extending from the body portion 73a and having a smaller diameter than the body portion 73a, and a projection 73c projecting from the body portion 73a toward a side opposite to the rod portion 73b. The rod portion 73b is slidably supported by a through hole 14d formed in an end part 14c of the solenoid tube 14, and the tip thereof is in contact with the piston 71. A plurality of disc springs 74 are arranged to overlap in the axial direction on the outer periphery of the projection 73c. These disc springs 74 are sandwiched between the body portion 73a of the pressing member 73 and the adjusting member 75.

The adjusting member 75 is a disc-shaped member and includes an externally threaded portion 75a formed on the outer peripheral surface and a recess 75b formed at a position facing the projection 73c. A depth of the recess 75b is set such that the disc springs 74 arranged between the pressing member 73 and the adjusting member 75 are not maximally contracted even when a tip part of the projection 73c is in contact with the bottom surface of the recess 75b. That is, the projection 73c of the pressing member 73 functions as a restricting portion that restricts a contraction amount of the disc springs 74.

On the end part 14c of the solenoid tube 14 supporting the rod portion 73b, a hollow cylindrical sleeve 72 is fixed along the axial direction to enclose the pressing member 73. The adjusting member 75 is threadably engaged with the inner peripheral surface of the sleeve 72 movably in the axial direction via the externally threaded portion 75a. The disc springs 74 are housed in the sleeve 72 while being sandwiched between the pressing member 73 and the adjusting member 75.

If the axial position of the adjusting member 75 is changed, the piston 71 is displaced in the axial direction via the disc springs 74 and the pressing member 73. According to this displacement, a compression amount of the sub-return spring 35 changes and an initial load of the sub-return spring 35 acting on the auxiliary valve 31 can be adjusted. As just described, the adjusting member 75 functions also as an adjusting member for adjusting the initial load of the sub-return spring 35 acting on the auxiliary valve 31.

It should be noted that since a spring constant of the disc spring 74 is set larger than that of the sub-return spring 35, the disc spring 74 is not compressed earlier than the sub-return spring 35 in adjusting the initial load. Various elastic members such as a coil spring may be used instead of the disc springs 74 if the elastic members have a spring constant larger than the sub-return spring 35.

The pressing member 73 and the like arranged to project in the axial direction from the solenoid tube 14 are covered by a cover 63 attached to the sleeve 72. Since the members constituting the pressure compensation unit 70 are provided outside the solenoid tube 14 as just described, the exchange of the disc springs 74 and the adjustment of the initial load of the sub-return spring 35 can be easily made by detaching the cover 63.

Next, the operation of the solenoid valve 100 is described.

When no current is supplied to the coil 62, the auxiliary valve 31 and the plunger 33 are pressed by the biasing force of the sub-return spring 35, the sub-poppet valve 31a of the auxiliary valve 31 is seated on the sub-seat portion 23c and the control pressure chamber 42 is closed. Thus, the pressure in the control pressure chamber 42 becomes equal to that of the first port 220 and a pressure equal to the pressure of the first port 220 acts on the valve closing pressure receiving surface A2.

Here, since the area of the valve closing pressure receiving surface A2 is set larger than the area of the valve opening pressure receiving surface A1, the resultant force of the thrust force by the pressure in the control pressure chamber 42 acting on the valve closing pressure receiving surface A2 and the biasing force of the main return spring 24 exceeds the thrust force by the pressure of the first port 220 acting on the valve opening pressure receiving surface A1, and the main valve 22 is biased in a direction to close the seat portion 13. As just described, when the coil 62 is in a non-conductive state, the flow of the hydraulic oil from the first port 220 to the second port 230 is blocked.

On the other hand, when a current is supplied to the coil 62, the plunger 33 exceeds the biasing force of the sub-return spring 35 and is attracted toward the coil 62 by a thrust force generated by the solenoid portion 60. Then, the auxiliary valve 31 is displaced together with the plunger 33, whereby the sub-poppet valve 31a is separated from the sub-seat portion 23c and a clearance is formed between the sub-poppet valve 31a and the sub-seat portion 23c. The hydraulic oil in the control pressure chamber 42 passes through the first communication passage 23a, the second communication passage 23b and the communication holes 12b through this clearance and is discharged to the second port 230.

Since the inflow of the hydraulic oil from the first port 220 into the control pressure chamber 42 is limited by the introducing hole 41 functioning as an orifice, the pressure in the control pressure chamber 42 decreases due to the communication between the control pressure chamber 42 and the second port 230. Then, the main valve 22 is displaced in a direction to open the seat portion 13 until the resultant force of the thrust force by the pressure in the control pressure chamber 42 acting on the valve closing pressure receiving surface A2 and the biasing force of the main return spring 24 and the thrust force by the pressure of the first port 220 acting on the valve opening pressure receiving surface A1 are balanced. As a result, the hydraulic oil flows from the first port 220 to the second port 230 through clearances between the through holes 22d and the first seat portion 13a and between the poppet valve 22b and the second seat portion 13b and the communication holes 12b.

When the current supplied to the coil 62 is increased, the sub-poppet valve 31a is further separated from the sub-seat portion 23c. As a result, the amount of the hydraulic oil discharged from the control pressure chamber 42 to the second port 230 increases and the pressure in the control pressure chamber 42 further decreases. Then, the main valve 22 further moves in the direction to open the seat portion 13 according to a reduction in the pressure in the control pressure chamber 42, and the areas of the through holes 22d of the spool valve 22a exposed from the first seat portion 13a increase. As a result, a flow rate of the hydraulic oil flowing from the first port 220 to the second port 230 increases.

As just described, the flow rate of the hydraulic oil flowing from the first port 220 to the second port 230 is controlled by increasing and decreasing the current supplied to the coil 62 and controlling a displacement amount of the main valve 22.

When energization to the coil 62 is stopped, the thrust force for attracting the plunger 33 is lost. Thus, the plunger 33 is pressed in the direction to seat the sub-poppet valve 31a on the sub-seat portion 23c by the biasing force of the sub-return spring 35. When the sub-poppet valve 31a of the auxiliary valve 31 is seated on the sub-seat portion 23c, the hydraulic oil in the first port 220 is introduced into the control pressure chamber 42 through the introducing hole 41 and the pressure in the control pressure chamber 42 increases to become equal to the pressure of the first port 220.

When the pressure in the control pressure chamber 42 becomes equal to that of the first port 220, the thrust force by the pressure of the first port 220 acting on the valve opening pressure receiving surface A1 falls below the resultant force of the thrust force by the pressure in the control pressure chamber 42 acting on the valve closing pressure receiving surface A2 and the biasing force of the main return spring 24. Thus, the main valve 22 is biased in the direction to close the seat portion 13. As a result, the main valve 22 is displaced in the direction to close the seat portion 13 and the flow of the hydraulic oil from the first port 220 to the second port 230 is blocked.

Next, the operation of the pressure compensation unit 70 is described.

If the pressure in the control pressure chamber 42 increases when the coil 62 is in the non-conductive state, the pressure in the back pressure chamber 44 communicating with the control pressure chamber 42 also increases. At this time, if a biasing force by the pressure in the back pressure chamber 44 acting on the piston 71 exceeds the biasing force of the disc springs 74, the piston 71 is displaced in a direction to expand the back pressure chamber 44.

Since the sub-return spring 35 extends due to a displacement of the piston 71, the biasing force of the sub-return spring 35 acting on the auxiliary valve 31 decreases according to an extension amount. That is, the biasing force of the sub-return spring 35 acting on the auxiliary valve 31 decreases as the pressure in the back pressure chamber 44 increases. Here, spring characteristics of the disc springs 74 are set such that the biasing force of the sub-return spring 35 decreases by as much as the biasing force by the pressure in the back pressure chamber 44 acting on the auxiliary valve 31 increases, i.e. a resultant force of these biasing forces is constantly fixed. Thus, a biasing force in the valve closing direction acting on the auxiliary valve 31 constantly has a fixed magnitude.

As just described, the pressure compensation unit 70 functions to maintain the biasing force in the valve closing direction acting on the auxiliary valve 31 at a substantially fixed magnitude even if the pressure in the back pressure chamber 44 communicating with the control pressure chamber 42 increases such as due to an increase in the pressure of the hydraulic oil supplied to the first port 220. By maintaining the biasing force in the valve closing direction acting on the auxiliary valve 31 at the substantially fixed magnitude, the auxiliary valve 31 is constantly driven and the main valve 22 is also opened according to this if a constant current is supplied to the coil 62. That is, by providing the pressure compensation unit 70, an increase of the thrust force required to attract the auxiliary valve 31 is suppressed and a stable flow rate of the hydraulic oil can be obtained according to the supplied current.

Further, if the pressure in the control pressure chamber 42 abnormally increases or momentarily suddenly increases, the disc springs 74 may be broken by being compressed beyond a contraction amount set in advance. In this embodiment, the breakage of the disc springs 74 can be prevented since the projection 73c of the pressing member 73 comes into contact with the bottom surface of the recess 75b to suppress a maximally contracted state of the disc springs 74 in such a case. It should be noted that the restricting portion that restricts the contraction amount of the disc springs 74 is not limited to the above configuration and may restrict, for example, a displacement of the piston 71 toward the pressing member 73. The restricting portion may have any configuration as long as a maximally contracted state of the disc springs 74 is suppressed.

According to the above first embodiment, the following functions and effects are exhibited.

In the solenoid valve 100, the pressure compensation unit 70 can change the biasing force of the sub-return spring 35 acting on the auxiliary valve 31 by a simple operation of expanding/contracting the back pressure chamber 44 according to the pressure in the control pressure chamber 42 without providing the main valve 22 with any member. Thus, the main valve 22 can have a simple shape and the biasing force acting on the auxiliary valve 31 by the simply configured pressure compensation unit 70 can be changed according to the pressure in the control pressure chamber 42. As a result, the structure of the solenoid valve 100 including the pressure compensation unit 70 can be simplified.

Further, since it is no longer necessary to provide the disc springs 74 having a relatively large outer diameter on the main valve 22, an outer diameter of the main valve 22 and the control pressure chamber 42 can be made smaller. Thus, an outer diameter of the sleeve 12 becomes smaller and the mountability of the solenoid valve 100 can be improved. Furthermore, if the outer diameter of the sleeve 12 becomes smaller, the area of the sleeve 12 coming into contact with the valve block 200 decreases and an axial force for fixing the solenoid valve 100 decreases. Thus, the rigidity of the fastening member 16 and the strength of the fastening bolt can be reduced. In addition, since it is no longer necessary to arrange a sliding member and the like in the main valve 22, the processing of the main valve 22 is facilitated and manufacturing cost can be suppressed.

Further, since the pressure compensation unit 70 is provided outside the solenoid tube 14, the exchange of the disc springs 74 and the adjustment of the initial load of the sub-return spring 35 can be easily made. Further, since an installation space for biasing means is not restricted as compared to the case where the disc springs 74 are provided on the main valve 22, it is possible to use an elastic member such as a coil spring having a high degree of freedom in design instead of the disc springs 74.

### Second Embodiment

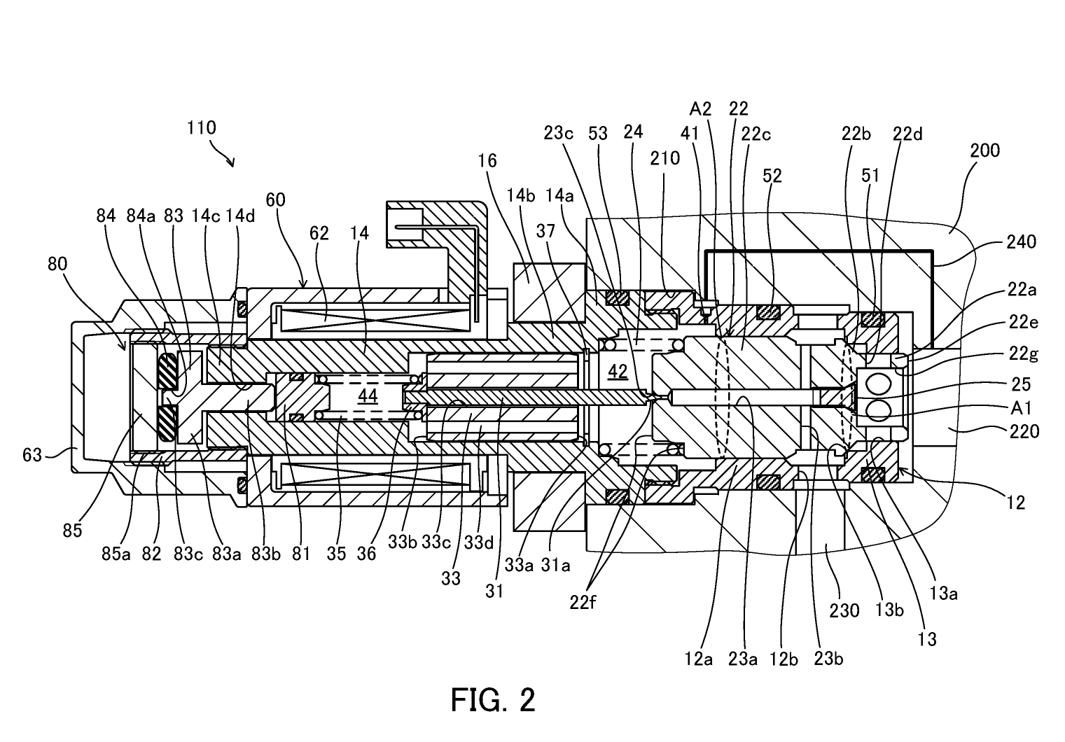

Next, a solenoid valve 110 according to a second embodiment of the present invention is described with reference to FIG. 2. The following description is centered on points of difference from the first embodiment and components similar to those of the first embodiment are denoted by the same reference signs and not described.

A basic configuration of the solenoid valve 110 is similar to that of the solenoid valve 100 according to the first embodiment. The solenoid valve 110 mainly differs from the solenoid valve 100 in that a rubber elastic body 84 is used as a second biasing member provided in a pressure compensation unit 80.

The pressure compensation unit 80 of the solenoid valve 110 includes the rubber elastic body 84, a piston 81 provided in a solenoid tube 14, a pressing member 83 that presses the piston 81 by coming into contact with the piston 81, and an adjusting member 85 arranged with the rubber elastic body 84 interposed between the pressing member 83 and the adjusting member 85.

The pressing member 83 includes a disc-shaped body portion 83a, a rod portion 83b extending from the body portion 83a and having a smaller diameter than the body portion 83a, and a projection 83c projecting from the body portion 83a toward a side opposite to the rod portion 83b. The rod portion 83b is slidably supported by a through hole 14d formed in an end part 14c of the solenoid tube 14, and the tip thereof is in contact with the piston 81.

The rubber elastic body 84 interposed between the pressing member 83 and the adjusting member 85 is formed into a circular annular shape and an insertion hole 84a into which the projection 83c is inserted is formed in a center of the rubber elastic body 84. By inserting the projection 83c of the pressing member 83 into the insertion hole 84a, a radial movement of the rubber elastic body 84 is restricted. A length of the projection 83c is set such that the rubber elastic body 84 arranged between the pressing member 83 and the adjusting member 85 is not maximally contracted even when a tip part of the projection 83c comes into contact with the adjusting member 85. That is, the projection 83c of the pressing member 83 functions as a restricting portion that restricts a contraction amount of the rubber elastic body 84.

The rubber elastic body 84 is formed of nitrile rubber or fluororubber or elastic elastomer such as silicone rubber excellent in compressive restoring force. Since the rubber elastic body 84 is provided at a location exposed to air without being in contact with the hydraulic oil, it is preferable to form the rubber elastic body 84 of elastomer excellent in weatherability.

On the end part 14c of the solenoid tube 14 supporting the rod portion 83b, a hollow cylindrical sleeve 82 is fixed along an axial direction to enclose the pressing member 83. The disc-shaped adjusting member 85 is threadably engaged with the inner peripheral surface of the sleeve 82 movably in the axial direction via an externally threaded portion 85a formed on the outer peripheral surface of the adjusting member 85. The rubber elastic body 84 is housed in the sleeve 82 while being sandwiched between the pressing member 83 and the adjusting member 85.

If the axial position of the adjusting member 85 is changed, the piston 81 is displaced in the axial direction via the rubber elastic body 84 and the pressing member 83. According to this displacement, a compression amount of a sub-return spring 35 changes and an initial load of the sub-return spring 35 acting on an auxiliary valve 31 can be adjusted. As just described, the adjusting member 85 functions also as an adjusting member for adjusting the initial load of the sub-return spring 35 acting on the auxiliary valve 31.

It should be noted that since a spring constant of the rubber elastic body 84 is set larger than that of the sub-return spring 35, the rubber elastic body 84 is not compressed earlier than the sub-return spring 35 in adjusting the initial load.

The pressing member 83 and the like arranged to project in the axial direction from the solenoid tube 14 are covered by a cover 63 attached to the sleeve 82. Since the members constituting the pressure compensation unit 80 are provided outside the solenoid tube 14 as just described, the exchange of the rubber elastic body 84 and the adjustment of the initial load of the sub-return spring 35 can be easily made by detaching the cover 63.

The operation of the solenoid valve 110 is not described since this operation is the same as the operation of the solenoid valve 100 of the above first embodiment.

Next, the operation of the pressure compensation unit 80 is described.

If a pressure in a control pressure chamber 42 increases when a coil 62 is in a non-conductive state, a pressure in a back pressure chamber 44 communicating with the control pressure chamber 42 also increases. At this time, if a biasing force by the pressure in the back pressure chamber 44 acting on the piston 81 exceeds a biasing force of the rubber elastic body 84, the rubber elastic body 84 is compressed and deformed via the pressing member 83. Then, the piston 81 is displaced in a direction to expand the back pressure chamber 44 according to a deformation amount of the rubber elastic body 84.

Since the sub-return spring 35 extends due to a displacement of the piston 81, the biasing force of the sub-return spring 35 acting on the auxiliary valve 31 decreases according to an extension amount. That is, the biasing force of the sub-return spring 35 acting on the auxiliary valve 31 decreases as the pressure in the back pressure chamber 44 increases. Here, spring characteristics of the rubber elastic body 84 are set such that the biasing force of the sub-return spring 35 decreases by as much as the biasing force by the pressure in the back pressure chamber 44 acting on the auxiliary valve 31 increases, i.e. a resultant force of these biasing forces is constantly fixed. Thus, a biasing force in a valve closing direction acting on the auxiliary valve 31 constantly has a fixed magnitude.

As just described, the pressure compensation unit 80 functions to maintain the biasing force in the valve closing direction acting on the auxiliary valve 31 at a substantially fixed magnitude even if the pressure in the back pressure chamber 44 communicating with the control pressure chamber 42 increases such as due to an increase in the pressure of the hydraulic oil supplied to a first port 220. By maintaining the biasing force in the valve closing direction acting on the auxiliary valve 31 at the substantially fixed magnitude, the auxiliary valve 31 is constantly driven and the main valve 22 is also opened according to this if a constant current is supplied to the coil 62. That is, by providing the pressure compensation unit 80, a thrust force required to attract the auxiliary valve 31 is fixed regardless of a pressure change of the control pressure chamber 42. Thus, a stable flow rate of hydraulic oil can be obtained according to a current supplied to the coil 62.

Further, if the pressure in the control pressure chamber 42 abnormally increases or momentarily suddenly increases, the rubber elastic body 84 may be broken by being compressed beyond a contraction amount set in advance. In this embodiment, the breakage of the rubber elastic body 84 can be prevented since the projection 83c of the pressing member 83 comes into contact with the adjusting member 85 to suppress a maximally contracted state of the rubber elastic body 84 in such a case. It should be noted that the restricting portion that restricts the contraction amount of the rubber elastic body 84 is not limited to the above configuration and may restrict, for example, a displacement of the piston 81 toward the pressing member 83. The restricting portion may have any configuration as long as a maximally contracted state of the rubber elastic body 84 is suppressed.

According to the above second embodiment, the following functions and effects are exhibited in addition to the functions and effects of the first embodiment.

In the solenoid valve 110, the rubber elastic body 84 is used as the second biasing member provided in the pressure compensation unit 80. Since the shape of the rubber elastic body 84 is freely set, the other members of the pressure compensation unit 80 such as the pressing member 83 and the adjusting member 85 can be freely designed and a degree of freedom in designing the solenoid valve 110 can be improved.

It should be noted that the shape of the rubber elastic body 84 is not limited to the circular annular shape as long as there is no possibility of breakage and the like caused by compression, and the rubber elastic body 84 may be formed into a disc shape. Further, the rubber elastic body 84 may be such that a plurality of rubber elastic bodies having different elastic properties are laminated in the axial direction. Further, elastic properties may be changed by making an internal material of the rubber elastic body 84 different or providing a space inside.

### Third Embodiment

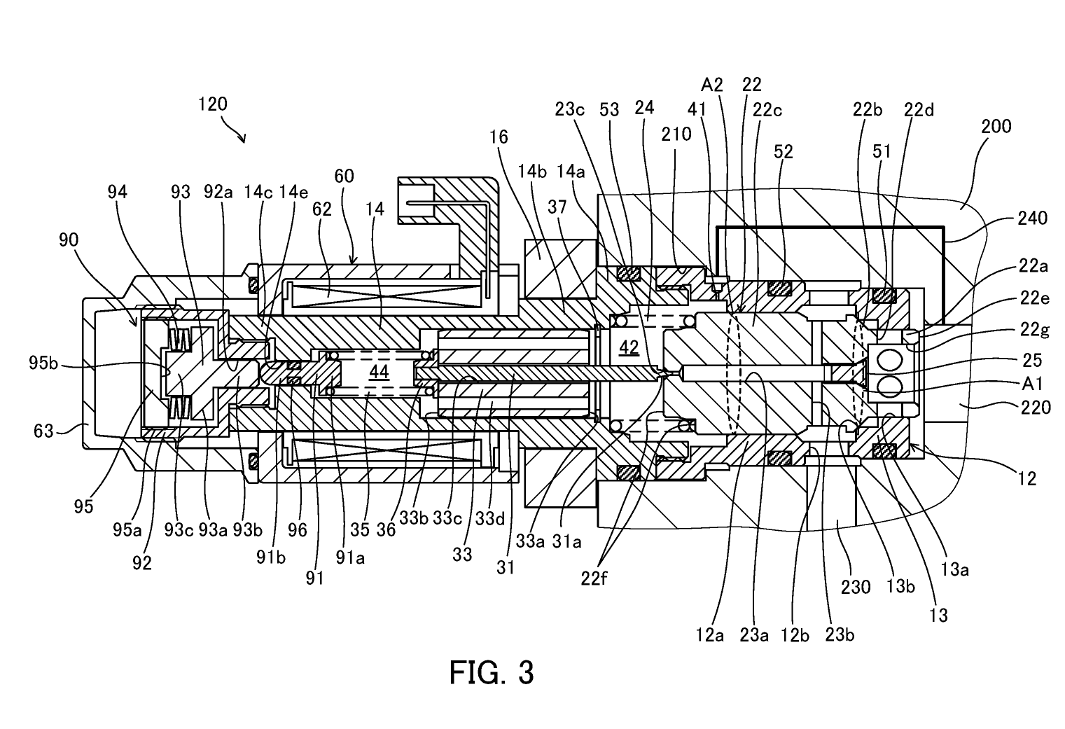

Next, a solenoid valve 120 according to a third embodiment of the present invention is described with reference to FIG. 3. The following description is centered on points of difference from the first embodiment and components similar to those of the first embodiment are denoted by the same reference signs and not described.

A basic configuration of the solenoid valve 120 is similar to that of the solenoid valve 100 according to the first embodiment. The solenoid valve 120 mainly differs from the solenoid valve 100 in that the piston 71 constituting the pressure compensation unit 70 slides along the back pressure chamber 44 housing the sub-return spring 35 in the solenoid valve 100, whereas a piston 91 slides along a sliding hole 14e provided in an end part 14c of a solenoid tube 14 in the solenoid valve 120.

Next, the configuration of the pressure compensation unit 90 of the solenoid valve 120 is described.

The pressure compensation unit 90 includes the cylindrical piston 91 provided in the solenoid tube 14, a pressing member 93 that presses the piston 91 by coming into contact with the piston 91, disc springs 94 serving as a second biasing member for biasing the pressing member 93 toward the piston 91, an adjusting member 95 arranged with the disc springs 94 interposed between the pressing member 93 and the adjusting member 95, and a sleeve 92 slidably supporting the pressing member 93 and having the adjusting member 95 threadably engaged therewith.

The piston 91 includes a spring receiving portion 91a having one end of a sub-return spring 35 locked thereto, and a sliding portion 91b formed to have a smaller diameter than the spring receiving portion 91a and slidably supported in the sliding hole 14e provided in the end part 14c of the solenoid tube 14. The sliding hole 14e slidably supporting the sliding portion 91b of the piston 91 is a through hole having one end open in a back pressure chamber 44 and has a diameter smaller than an inner diameter of the back pressure chamber 44 and an outer diameter of the sub-return spring 35. The sliding portion 91b is arranged with the tip thereof exposed from the solenoid tube 14.

An O-ring 96 is provided on the outer periphery of the sliding portion 91b. The leakage of hydraulic oil from the back pressure chamber 44 to outside is prevented by the O-ring 96 compressed by the sliding portion 91b and the sliding hole 14e.

One end side of the sleeve 92 is inserted and coupled to the end part 14c of the solenoid tube 14 where the sliding portion 91b is exposed. The sleeve 92 is provided with a sliding hole 92a for slidably supporting the pressing member 93 at a position facing the sliding portion 91b. The sleeve 92 includes a threaded portion, with which the adjusting member 95 is threadably engaged, on the inner peripheral surface of the other end side.

The pressing member 93 includes a disc-shaped body portion 93a to be housed into the sleeve 92, a rod portion 93b extending from the body portion 93a and having a smaller diameter than the body portion 93a, and a projection 93c projecting from the body portion 93a toward a side opposite to the rod portion 93b. The rod portion 93b is slidably supported by the sliding hole 92a of the sleeve 92, and the tip thereof comes into contact with the sliding portion 91b of the piston 91.

Since the structures and functions of the other members are similar to those of the solenoid valve 100 according to the above first embodiment, they are not described.

Next, the operation of the pressure compensation unit 90 is described.

If a pressure in a control pressure chamber 42 increases when a coil 62 is in a non-conductive state, a pressure in the back pressure chamber 44 communicating with the control pressure chamber 42 also increases. At this time, if a biasing force by the pressure in the back pressure chamber 44 acting on the piston 91 exceeds a biasing force of the disc springs 94, the piston 91 is displaced in a leftward direction in FIG. 3.

Since the sub-return spring 35 extends due to a displacement of the piston 91, a biasing force of the sub-return spring 35 acting on an auxiliary valve 31 decreases according to an extension amount. That is, the biasing force of the sub-return spring 35 acting on the auxiliary valve 31 decreases as the pressure in the back pressure chamber 44 increases. Here, spring characteristics of the disc springs 94 are set such that the biasing force of the sub-return spring 35 decreases by as much as the biasing force by the pressure in the back pressure chamber 44 acting on the auxiliary valve 31 increases, i.e. a resultant force of these biasing forces is constantly fixed. Thus, a biasing force in a valve closing direction acting on the auxiliary valve 31 constantly has a fixed magnitude.

As just described, the pressure compensation unit 90 functions similarly to the pressure compensation unit 70 of the solenoid valve 100 according to the above first embodiment.

Here, in the case of using ready-made articles as the disc springs 94, a force to be transmitted to the disc springs 94 has to be set in accordance with properties of the ready-made articles. For example, in the above first embodiment, it is necessary to change the outer diameter of the piston 71 and change the inner diameter of the back pressure chamber 44, which is a non-penetrating hole, in order to change a force to be transmitted to the disc springs 74. Further, since the inner diameter of the back pressure chamber 44 is set larger than the outer diameter of the sub-return spring 35, a drastic design change is required to reduce the force to be transmitted to the disc springs 74.

In contrast, in the pressure compensation unit 90, a force to be transmitted to the disc springs 94 is determined by a cross-sectional area of the sliding portion 91b of the piston 91 on which the pressure in the back pressure chamber 44 is acting. That is, the force to be transmitted to the disc springs 94 can be appropriately changed only by changing the outer diameter of the sliding portion 91b and the inner diameter of the sliding hole 14e. Since the outer diameter of the sliding portion 91b and the inner diameter of the sliding hole 14e are not limited unlike the back pressure chamber 44, these dimensions can be freely set. Thus, it becomes possible to improve a degree of freedom in designing the solenoid valve 120 and use inexpensive ready-made articles, whereby the manufacturing cost of the solenoid valve 120 can be suppressed.

According to the above third embodiment, the following functions and effects are exhibited in addition to the functions and effects of the first embodiment.

In the solenoid valve 120, the force to be transmitted to the disc springs 94 can be changed only by changing the outer diameter of the sliding portion 91b of the piston 91. Thus, even in the case of using ready-made articles as the disc springs 94, a force acting on the disc springs 94 can be properly set. As a result, it is possible to improve a degree of freedom in designing the solenoid valve 120 and suppress the manufacturing cost of the solenoid valve 120 by enabling the use of inexpensive ready-made articles.

It should be noted that, in the above third embodiment, the disc springs 94 are used as the second biasing member provided in the pressure compensation unit 90. Instead of this, a rubber elastic body may be used as the second biasing member as in the second embodiment. Further, in the above third embodiment, the projection 93c of the pressing member 93 functions as the restricting portion that restricts the contraction amount of the disc springs 94. Instead of this, the contraction amount of the disc springs 94 may be restricted by the contact of the spring receiving portion 91a of the piston 91 with the inner surface of the solenoid tube 14 when the disc springs 94 are contracted more than a predetermined amount.

The configurations, functions and effects of the embodiments of the present invention are summarily described below.

The solenoid valve 100, 110, 120 includes the main valve 22 that changes the communication opening degree between the first and second ports 220, 230, the control pressure chamber 42 that biases the main valve 22 in the valve closing direction by having the hydraulic oil introduced thereto from the first port 220, the first and second communication passages 23a, 23b formed in the main valve 22 and that allow communication between the control pressure chamber 42 and the second port 230, the auxiliary valve 31 that opens and close the first and second communication passages 23a, 23b, the solenoid portion 60 that displaces the auxiliary valve 31 according to the supplied current, the back pressure chamber 44 communicating with the control pressure chamber 42 and that biases the auxiliary valve 31 in the valve closing direction, the sub-return spring 35 housed in the back pressure chamber 44 and that biases the auxiliary valve 31 in the valve closing direction, and the pressure compensation unit 70, 80, 90 that change the biasing force of the sub-return spring 35 acting on the auxiliary valve 31 according to the pressure in the back pressure chamber 44.

In this configuration, the pressure compensation unit 70, 80, 90 can change the biasing force of the sub-return spring 35 acting on the auxiliary valve 31 according to the pressure in the back pressure chamber 44 without providing the main valve 22 with any member. Thus, the main valve 22 can have a simple shape and the biasing force acting on the auxiliary valve 31 can be changed by the simply configured pressure compensation unit 70, 80, 90. As a result, the structure of the solenoid valve 100, 110, 120 including the pressure compensation unit 70, 80, 90 can be simplified.

Further, the pressure compensation unit 70, 80, 90 includes the piston 71, 81, 91 to be movably housed in the back pressure chamber 44, and the sub-return spring 35 is interposed in a compressed state between the auxiliary valve 31 and the piston 71, 81, 91 in the back pressure chamber 44.

In this configuration, the pressure compensation unit 70, 80, 90 can change the biasing force of the sub-return spring 35 acting on the auxiliary valve 31 by a simple operation of displacing the piston 71, 81, 91 housed in the back pressure chamber 44 without providing the main valve 22 with any member. As a result, the structure of the solenoid valve 100, 110, 120 including the pressure compensation unit 70, 80, 90 can be simplified.

Further, the pressure compensation unit 70, 80, 90 includes the disc springs 74, 94 or the rubber elastic body 84 that biases the piston 71, 81, 91 against the pressure in the back pressure chamber 44 and the biasing force of the sub-return spring 35.

In this configuration, the pressure compensation unit 70, 80, 90 can change the biasing force of the sub-return spring 35 acting on the auxiliary valve 31 by a simple operation of displacing the piston 71, 81, 91 against the biasing force of the disc springs 74, 94 or the rubber elastic body 84 without providing the main valve 22 with any member. As a result, the structure of the solenoid valve 100, 110, 120 including the pressure compensation unit 70, 80, 90 can be simplified.

Further, the solenoid valve 100, 110, 120 also includes the adjusting member 75, 85, 95 that adjust the initial load of the sub-return spring 35 acting on the auxiliary valve 31, and the disc springs 74, 94 or the rubber elastic body 84 are/is interposed between the adjusting member 75, 85, 95 and the piston 71, 81, 91.

In this configuration, the piston 71, 81, 91 has two functions of being displaced by the adjusting member 75, 85, 95 to adjust the initial load of the sub-return spring 35 and changing the biasing force of the sub-return spring 35 according to the pressure in the control pressure chamber 42. As a result, the structure of the solenoid valve 100, 110, 120 including the pressure compensation unit 70, 80, 90 can be simplified.

Further, the disc springs 74, 94 or the rubber elastic body 84 are/is formed of member(s) that exhibits a biasing force according to a contraction amount, and the pressure compensation unit 70, 80, 90 further includes the projection 73c, 83c, 93c that restrict the contraction amount of the disc springs 74, 94 or the rubber elastic body 84.

In this configuration, since the projection 73c, 83c, 93c of the pressing member 73, 83, 93 comes into contact with the adjusting member 75, 85, 95, a maximally contracted state of the disc springs 74, 94 or the rubber elastic body 84 is suppressed. Thus, even if the pressure in the control pressure chamber 42 abnormally increases or momentarily suddenly increases, the breakage of the disc springs 74, 94 or the rubber elastic body 84 can be prevented.

The embodiments of the present invention described above are merely illustration of some application examples of the present invention and not of the nature to limit the technical scope of the present invention to the specific constructions of the above embodiments.

For example, although the solenoid valve 100, 110, 120 controls the flow of the hydraulic oil from the first port 220 to the second port 230 in the above embodiments, there is no limitation to this and the solenoid valve may be a bidirectional flow control valve also capable of controlling the flow of the hydraulic oil from the second port 230 to the first port 220.

The present application claims a priority based on Japanese Patent Application No. 2015-182855 filed with the Japan Patent Office on Sep. 16, 2015, all the contents of which are hereby incorporated by reference.

1. A solenoid valve for controlling a flow rate of working fluid flowing from a first port to a second port, comprising:
a main valve configured to change a communication opening degree between the first port and the second port;
a control pressure chamber configured to bias the main valve in a valve closing direction by having the working fluid introduced thereto from the first port;
a communication passage formed in the main valve, the communication passage being configured to allow communication between the control pressure chamber and the second port;
an auxiliary valve configured to open and close the communication passage;
a solenoid portion configured to displace the auxiliary valve according to a supplied current;
a back pressure chamber communicating with the control pressure chamber, the back pressure chamber being configured to bias the auxiliary valve in a valve closing direction;
a first biasing member housed in the back pressure chamber, the first biasing member being configured to bias the auxiliary valve in the valve closing direction; and
a pressure compensation unit configured to change a biasing force of the first biasing member acting on the auxiliary valve according to a pressure in the back pressure chamber.

2. The solenoid valve according to claim 1, wherein
the pressure compensation unit includes a piston to be movably housed in the back pressure chamber, and
the first biasing member is interposed in a compressed state between the auxiliary valve and the piston in the back pressure chamber.

3. The solenoid valve according to claim 2, wherein
the pressure compensation unit includes a second biasing member configured to bias the piston against the pressure in the back pressure chamber and the biasing force of the first biasing member.

4. The solenoid valve according to claim 3, further comprising:
an adjusting member configured to adjust an initial load of the first biasing member acting on the auxiliary valve, wherein
the second biasing member is interposed between the adjusting member and the piston.

5. The solenoid valve according to claim 3, wherein
the second biasing member is formed of a member configured to exhibit a biasing force according to a contraction amount, and
the pressure compensation unit further includes a restricting portion configured to restrict the contraction amount of the second biasing member.
